(19) United States
(12) Patent Application Publication
(10) Pub. No.: US 2026/0038759 A1
(43) Pub. Date: Feb. 5, 2026

(54) ACTUATOR APPARATUS FOR ELECTRICAL PANEL SWITCH

(71) Applicant: Faraday Defense Corporation, Kalamazoo, MI (US)

(72) Inventors: Jason R. DeVries, Kalamazoo, MI (US); Paul R. Steuer, Hawthorn Woods, IL (US); Arthur Thomas Bradley, Williamsburg, VA (US)

(73) Assignee: Faraday Defense Corporation, Kalamazoo, MI (US)

(21) Appl. No.: 19/308,190

(22) Filed: Aug. 23, 2025

Related U.S. Application Data
(63) Continuation-in-part of application No. PCT/US2023/065412, filed on Apr. 5, 2023.
Application No. PCT/US2023/065412 is a continuation-in-part of application No. 17/649,919, filed on Feb. 3, 2022, now Pat. No. 11,990,746.
(60) Provisional application No. 63/251,090, filed on Oct. 1, 2021.
(60) Provisional application No. 63/695,908, filed on Sep. 18, 2024.

(51) Int. Cl. H01H 71/42; H01H 3/26; H01H 3/40; H01H 71/04; H01H 71/52

(52) U.S. Cl. CPC H01H 71/42; H01H 3/40; H01H 71/04; H01H 71/521; H01H 2003/268; H01H 2071/046

(57) ABSTRACT

An actuator is disposed on a face of a circuit breaker panel positioned at a switch lever of a circuit breaker for moving the switch lever. A shaft selectively moves between an extended position and a retracted positon. An arm extends substantially perpendicular to the shaft. A manually disconnectable coupling is between the shaft and the arm. The arm is configured to fit on the face in a position to automatically move the switch lever into an electrically open positon from an electrically closed position upon activation of the actuator. The manually disconnectable coupling disconnects the shaft from the arm before a user manually moves the switch lever back into the electrically closed position. The manually disconnectable coupling has a manually removable pin. The actuator is a liner actuator and can be a rotational actuator.

### CROSS-REFERENCE TO RELATED APPLICATIONS

This application claims priority to and is related to U.S. provisional application No. 63/695,908, filed on Sep. 18, 2024. This application also claims priority as a continuation-in-part to U.S. designated non-provisional application number PCT/US23/65412 filed on Apr. 5, 2023, which claims priority to U.S. non-provisional application Ser. No. 17/649,919, filed on Feb. 3, 2021, which claims priority to U.S. provisional application No. 63/251,090, filed on Oct. 1, 2021. Such prior application(s) are incorporated herein by reference as if set forth in full herein.

### BACKGROUND OF THE INVENTIONS

### 1. Technical Field

The present inventions relate to automated circuit breakers and, more particularly, relate to actuators deployable on a face of a circuit breaker panel.

### 2. Description of the Related Art

Automatic switching circuit breakers for protection are known for high current applications. Complex apparatus for circuit interruption for overvoltage conditions are also known. These systems use custom inline switches.

What is needed is an improved way to interrupt an existing circuit with minimum installation complexity.

### SUMMARY OF THE INVENTIONS

An object of the present inventions is to interrupt a circuit without electrical or internal modification of an existing circuit breaker panel.

A further object of the present inventions is to interrupt a circuit without being installed into existing wiring.

Another further object of the present inventions is to not require an electrician for installation and are easily compliant with electrical codes.

A further other object of the present inventions is to use a linear actuator or rotational actuator.

A further additional object of the present inventions is to provide an actuator configuration that does not require backup power or a battery to maintain operation after power has been cut off.

An additional object of the present inventions is to accommodate a user manual reset apparatus and procedure when no power is available to electrically move the actuator back because power has already been cut off.

Another object of the present inventions is to interrupt a circuit to protect from an E3 EMP (E3 Electromagnetic Pulse) or a CME (Coronial Mass Ejection.)

### BRIEF DESCRIPTION OF THE DRAWINGS

The present inventions are illustrated by way of example and are not limited by the accompanying figures, in which like references indicate similar elements. Elements in the figures are illustrated for simplicity and clarity and have not necessarily been drawn to scale.

The details of the preferred embodiments and these and other objects and features of the inventions will be more readily understood from the following detailed description when read in conjunction with the accompanying drawings wherein:

FIG. 1 illustrates a plan view of an actuator deployed on a face of a circuit breaker panel next to a switch lever of a circuit breaker in a horizontal orientation with a vertical arm according to embodiments of the present inventions;

FIG. 2 illustrates a plan view of an actuator deployed on a face of a circuit breaker panel next to a switch lever of a circuit breaker in an opposite horizontal orientation with a reversed vertical arm according to embodiments of the present inventions;

FIG. 3 illustrates a plan view of an actuator deployed on a face of a circuit breaker panel next to a switch lever of a circuit breaker in a vertical orientation with a horizontal arm according to embodiments of the present inventions;

FIGS. 4-11 illustrate a chronological series of perspective views of an actuator deployed on a face of a circuit breaker panel during steps of operation according to embodiments of the present inventions;

FIG. 4 illustrates a perspective view of the actuator deployed on a face of a circuit breaker panel when the actuator and the arm are both in retracted positions and the switch lever of a circuit breaker is in an electrically closed position according to embodiments of the present inventions;

FIG. 5 illustrates a perspective view of the actuator deployed on a face of a circuit breaker panel when the actuator and the arm are both in extended positions and the switch lever of a circuit breaker is in an electrically open position according to embodiments of the present inventions;

FIG. 6 illustrates a perspective view of the actuator deployed on a face of a circuit breaker panel with a manually disconnectable coupling removed when the actuator and the arm are both in extended positons and the switch lever is the electrically open position according to embodiments of the present inventions;

FIG. 7 illustrates a perspective view of the actuator deployed on a face of a circuit breaker panel and a user's finger sliding the arm from the extended positon back to the retracted positon with the manually disconnectable coupling removed when the actuator is in the extended position and the switch lever is on the electrically open position according to embodiments of the present inventions;

FIG. 8 illustrates a perspective view of the actuator deployed on a face of a circuit breaker panel and the user's finger moving the switch lever is from the open positon to back to the electrically closed position with the manually disconnectable coupling removed when the arm is in the retracted positon and the actuator is in the extended position according to embodiments of the present inventions;

FIG. 9 illustrates a perspective view of the actuator deployed on a face of a circuit breaker panel with the manually disconnectable coupling removed when the arm is in the retracted positon and the actuator is in the extended position and the switch lever is in the electrically closed position according to embodiments of the present inventions;

FIG. 10 illustrates a perspective view of the actuator deployed on a face of a circuit breaker panel with the manually disconnectable coupling removed when the arm is in the retracted positon and the actuator is in the retracted position and the switch lever is in the electrically closed position according to embodiments of the present inventions;

FIG. 11 illustrates a perspective view of the actuator deployed on a face of a circuit breaker panel with the manually disconnectable coupling re-inserted by the user's finger when the arm is in the retracted positon and the actuator is in the retracted position and the switch lever is in the electrically closed position according to embodiments of the present inventions;

FIG. 12 illustrates an exploded perspective view of an alarm circuit with a circuit board and antenna, an activation button, a direction switch, and a housing, AC power prongs, and a wire coupled to a motor of the actuator according to embodiments of the present inventions;

FIG. 13 illustrates a schematic block diagram of the apparatus system including the alarm circuit and the actuator and the arm of an end effector according to embodiments of the present inventions;

FIG. 14 illustrates a perspective view of a rotational actuator having a rotary geared motor with a rotating shaft according to alternative embodiments of the present inventions;

FIG. 15 illustrates a perspective view of a rotational actuator having a rotary geared motor with a rotating cam according to alternative embodiments of the present inventions; and

FIG. 16 illustrates a perspective view of a rotational actuator with a removable end effector next to a breaker deployed on a face of a circuit breaker panel next to a switch lever of a circuit breaker according to alternative embodiments of the present inventions.

### DETAILED DESCRIPTION OF THE PREFERRED EMBODIMENTS

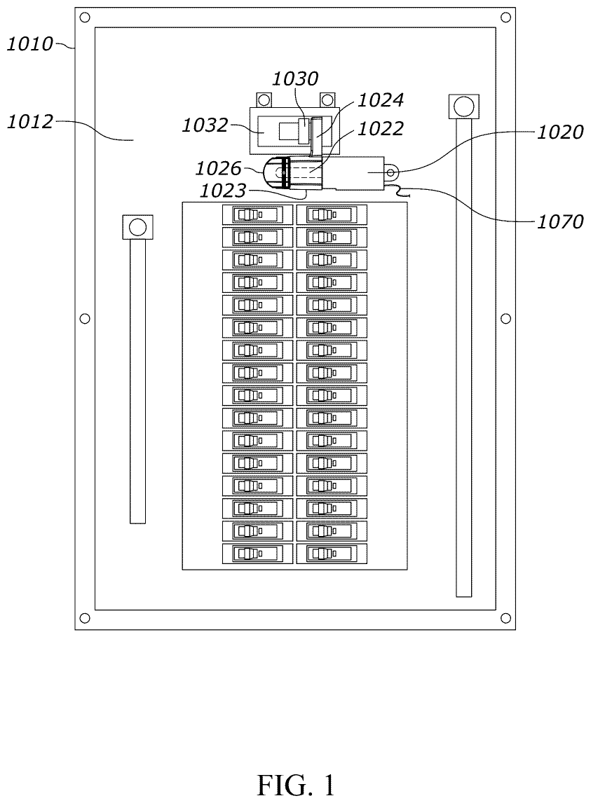

FIG. 1 illustrates a plan view of an actuator 1020 deployed on a face 1012 of a circuit breaker 1032 panel 1010 next to a switch lever 1030 of a circuit breaker 1032 in a horizontal orientation with a vertical arm 1024 according to embodiments of the present inventions. In this embodiment, the actuator 1020 is a linear actuator 1020 disposed on the face 1012 of the circuit breaker panel 1010 positioned at a switch lever 1030 of the circuit breaker 1032 for moving to electrically open the switch lever 1030 of the circuit breaker 1032. A shaft 1022 selectively longitudinally moves by extending and retracting between an extended position and a retracted positon. An arm 1024 extends substantially perpendicular to the shaft 1022. A manually disconnectable coupling 1026 connects between the shaft 1022 and the arm 1024.

The arm 1024 of the linear actuator 1020 is configured to fit on the face 1012 of the circuit breaker panel 1010 in a position to automatically move the switch lever 1030 into an electrically open positon 5031 from an electrically closed position 4031 upon activation of the linear actuator 1020. The manually disconnectable coupling 1026 is configured to disconnect the shaft 1022 from the arm 1024 before manually moving the switch lever 1030 back into the electrically closed position 4031. The arm 1024 of the linear actuator 1020 can be mounted 1 or 2 millimeters (0.04 or 0.08 inches) from the switch lever 1030 with about a 10 millimeter (0.4 inch) travel distance between extended and retracted positons.

The linear actuator 1020 is a linear actuator 1020 with a gear reduction gearbox between an electric motor and the shaft 1022. The electric motor can be a DC motor or an AC motor. The gear reduction gearbox provides speed reduction and torque improvement. The gear reduction gearbox is smaller than a solenoid and saves space.

The manually disconnectable coupling 1026 has a sleeve 1023 sized to fit over the shaft 1022. The arm 1024 can be integrally formed of the same material as the sleeve 1023.

A wire 1070 connects the linear actuator 1020 to an alarm circuit for operation of the actuator. The alarm circuit detects a predetermined power condition and activate movement of the shaft 1022 on the linear actuator 1020 upon occurrence of the predetermined power condition. The predetermined power condition detected by the alarm circuit is an E3 EMP (E3 Electromagnetic Pulse) or a CME (Coronial Mass Ejection) or both.

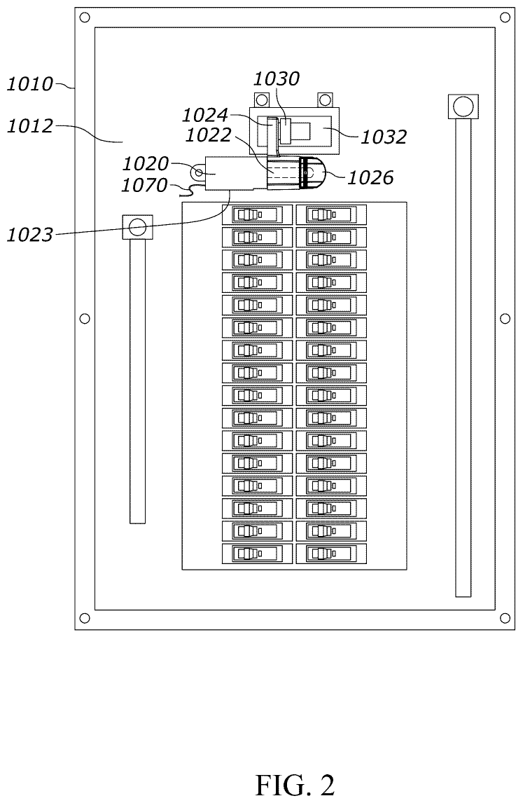

FIG. 2 illustrates a plan view of an actuator 1020 deployed on a face 1012 of a circuit breaker panel 1010 next to a switch lever 1030 of a circuit breaker 1032 in an opposite horizontal orientation with a reversed vertical arm 1024 according to embodiments of the present inventions.

The manually disconnectable coupling 1026 has a sleeve 1023 sized to fit over the shaft 1022. The arm 1024 can be integrally formed of the same material as the sleeve 1023. The sleeve 1023 couples to the arm 1024 such that the sleeve accommodates a 180 degree reversible position of the arm 1024 on the shaft 1022. Reversing the positon 180 degrees adapts to accommodate various circuit breaker panel 1010 layout configurations.

The orientation of the arm 1024 on the shaft 1022 in FIG. 1 is rotated 180 degrees from the orientation of the arm 1024 on the shaft 1022 of FIG. 2 to match the respective left or right horizontal locations of the different circuit breakers 1032 in FIGS. 1 and 2.

In this embodiment, the actuator 1020 is a linear actuator 1020 disposed on the face 1012 of the circuit breaker panel 1010 positioned at a switch lever 1030 of the circuit breaker 1032 for moving to electrically open the switch lever 1030 of the circuit breaker 1032. A shaft 1022 selectively longitudinally moves by extending and retracting between an extended position and a retracted positon. An arm 1024 extends substantially perpendicular to the shaft 1022. A manually disconnectable coupling 1026 connects between the shaft 1022 and the arm 1024.

The arm 1024 of the linear actuator 1020 is configured to fit on the face 1012 of the circuit breaker panel 1010 in a position to automatically move the switch lever 1030 into an electrically open positon 5031 from an electrically closed position 4031 upon activation of the linear actuator 1020. The manually disconnectable coupling 1026 is configured to disconnect the shaft 1022 from the arm 1024 before manually moving the switch lever 1030 back into the electrically closed position 4031. The arm 1024 of the linear actuator 1020 can be mounted 1 or 2 millimeters (0.04 or 0.08 inches) from the switch lever 1030 with about a 10 millimeter (0.4 inch) travel distance between extended and retracted positons.

The linear actuator 1020 is a linear actuator 1020 with a gear reduction gearbox between an electric motor and the shaft 1022. The electric motor can be a DC motor or an AC motor. The gear reduction gearbox provides speed reduction and torque improvement. The gear reduction gearbox is smaller than a solenoid and saves space.

The manually disconnectable coupling 1026 has a sleeve 1023 sized to fit over the shaft 1022. The arm 1024 can be integrally formed of the same material as the sleeve 1023.

A wire 1070 connects the linear actuator 1020 to an alarm circuit for operation of the actuator. The alarm circuit detects a predetermined power condition and activate movement of the shaft 1022 on the linear actuator 1020 upon occurrence of the predetermined power condition. The predetermined power condition detected by the alarm circuit is an E3 EMP (E3 Electromagnetic Pulse) or a CME (Coronial Mass Ejection) or both.

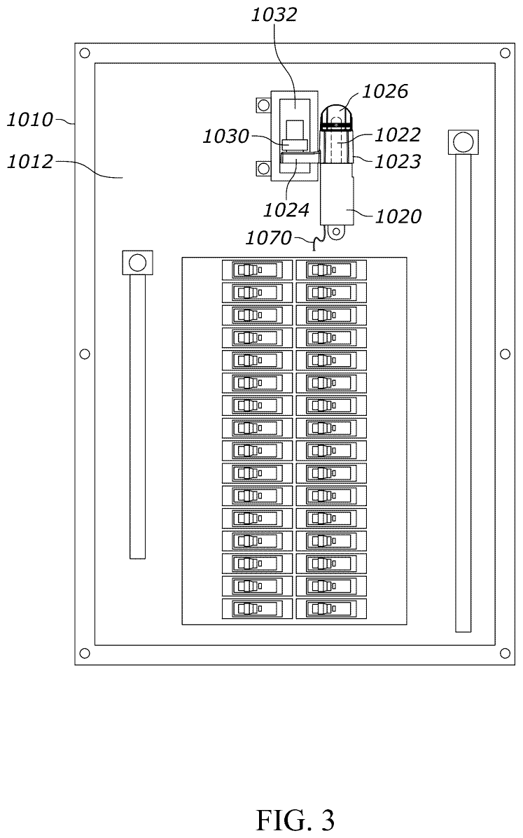

FIG. 3 illustrates a plan view of an actuator 1020 deployed on a face 1012 of a circuit breaker panel 1010 next to a switch lever 1030 of a circuit breaker 1032 in a vertical orientation with a horizontal arm 1024 according to embodiments of the present inventions.

The manually disconnectable coupling 1026 has a sleeve 1023 sized to fit over the shaft 1022. The arm 1024 can be integrally formed of the same material as the sleeve 1023.

The horizontal orientation of the linear actuator 1020 in FIG. 1 is different than the vertical orientation of the linear actuator 1020 of FIG. 3 to match the respective different horizontal and vertical orientations of the circuit breaker 1032 in FIGS. 1 and 3.

In this embodiment, the actuator 1020 is a linear actuator 1020 disposed on the face 1012 of the circuit breaker panel 1010 positioned at a switch lever 1030 of the circuit breaker 1032 for moving to electrically open the switch lever 1030 of the circuit breaker 1032. A shaft 1022 selectively longitudinally moves by extending and retracting between an extended position and a retracted positon. An arm 1024 extends substantially perpendicular to the shaft 1022. A manually disconnectable coupling 1026 connects between the shaft 1022 and the arm 1024.

The arm 1024 of the linear actuator 1020 is configured to fit on the face 1012 of the circuit breaker panel 1010 in a position to automatically move the switch lever 1030 into an electrically open positon 5031 from an electrically closed position 4031 upon activation of the linear actuator 1020. The manually disconnectable coupling 1026 is configured to disconnect the shaft 1022 from the arm 1024 before manually moving the switch lever 1030 back into the electrically closed position 4031. The arm 1024 of the linear actuator 1020 can be mounted 1 or 2 millimeters (0.04 or 0.08 inches) from the switch lever 1030 with about a 10 millimeter (0.4 inch) travel distance between extended and retracted positons.

The linear actuator 1020 is a linear actuator 1020 with a gear reduction gearbox between an electric motor and the shaft 1022. The electric motor can be a DC motor or an AC motor. The gear reduction gearbox provides speed reduction and torque improvement. The gear reduction gearbox is smaller than a solenoid and saves space.

The manually disconnectable coupling 1026 has a sleeve 1023 sized to fit over the shaft 1022. The arm 1024 can be integrally formed of the same material as the sleeve 1023.

A wire 1070 connects the linear actuator 1020 to an alarm circuit for operation of the actuator. The alarm circuit detects a predetermined power condition and activate movement of the shaft 1022 on the linear actuator 1020 upon occurrence of the predetermined power condition. The predetermined power condition detected by the alarm circuit can be an E3 EMP (E3 Electromagnetic Pulse) or a CME (Coronial Mass Ejection) or both.

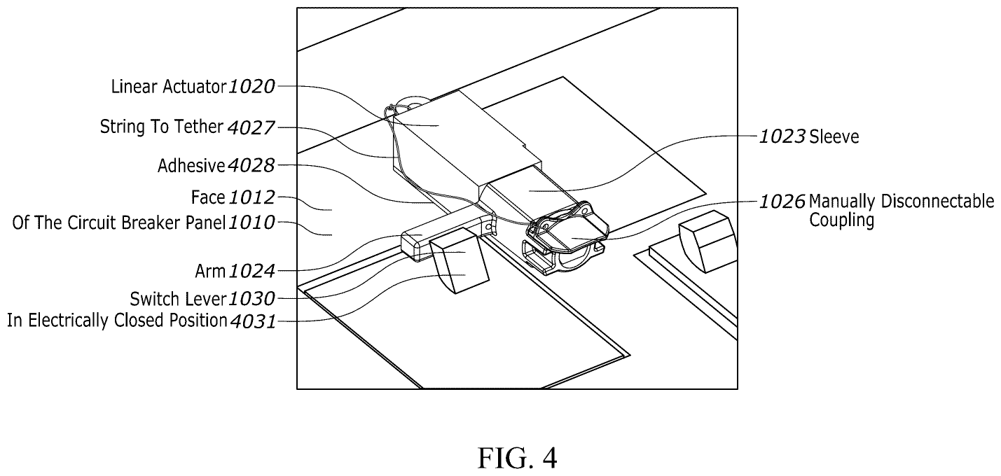

FIGS. 4-11 illustrate a chronological series of perspective views of a linear actuator 1020 deployed on a face 1012 of a circuit breaker panel 1010 during steps of operation according to embodiments of the present inventions.

The embodiments of FIGS. 4-11 illustrate various components for a linear actuator system arranged as deployed on the face 1012 of the circuit breaker panel 1010. The he actuator 1020 in these embodiments is a linear actuator 1020 disposed on the face 1012 of the circuit breaker panel 1010 positioned at a switch lever 1030 of the circuit breaker 1032 for moving to electrically open the switch lever 1030 of the circuit breaker 1032. A shaft 1022 selectively longitudinally moves by extending or retracting between an extended position and a retracted positon. An arm 1024 extends substantially perpendicular to the shaft 1022. A manually disconnectable coupling 1026 connects between the shaft 1022 and the arm 1024.

FIGS. 4-11 illustrate the arm 1024 of the linear actuator 1020 configured to fit on the face 1012 of the circuit breaker panel 1010 in a position to automatically move the switch lever 1030 into an electrically open positon 5031 from an electrically closed position 4031 upon activation of the linear actuator 1020. The manually disconnectable coupling 1026 is configured to disconnect the shaft 1022 from the arm 1024 before manually moving the switch lever 1030 back into the electrically closed position 4031.

The manually disconnectable coupling 1026 has a manually removable pin 1024 that fits in a shaft hole in the shaft 1022 and a sleeve hole 1027 in the sleeve 1023 to selectively couple the shaft 1022. The arm 1024 can be integrally formed of the same material as the sleeve 1023.

The manually disconnectable coupling 1026 has a sleeve 1023 sized to fit over the shaft 1022. The arm 1024 can be integrally formed of the same material as the sleeve 1023.

A string tether 4027 tethers the manually disconnectable coupling 1026 to the linear actuator 1020.

The manually disconnectable coupling 1026 can be made of a bright color plastic or a phosphorescent material to locate if dropped in dark.

An adhesive 1028 such as double sided foam sticky tape adheres the actuator 1020 to the face 1012 of the circuit breaker panel 1010. Although screws into the face 1012 of the circuit breaker panel 1010 can be used, an adhesive improves electrical safety because a metallic screw might inadvertently contact a wire in the circuit breaker panel 1010. Although magnets can be used to adhere the actuator 1020 to the face 1012 of the circuit breaker panel 1010, an adhesive is less prone to inadvertent movement than even a strong a magnet.

FIG. 4 illustrates a perspective view of the actuator 1020 deployed on a face 1012 of a circuit breaker panel 1010 in a normal ready operation when the actuator 1020 and the arm 1024 are both in retracted positions and the switch lever 1030 is in an electrically closed position according to embodiments of the present inventions. The arm 1024 of the linear actuator 1020 configured to fit on the face 1012 of the circuit breaker panel 1010 in a position to automatically move the switch lever 1030 into an electrically open positon 5031 from an electrically closed position 4031 upon activation of the linear actuator 1020.

The method of operating begins as illustrated in FIG. 4. The method of operating an actuator 1020 disposed on a face 1012 of a circuit breaker panel 1010 for moving a switch lever 1030 of a circuit breaker 1032 begins as illustrated in FIG. 4 by the step of adhering a linear actuator 1020 on a face 1012 of a circuit breaker panel 1010, the linear actuator 1020 having a shaft 1022 that selectively moves to extends and retracts between an extended position and a retracted positon longitudinally and having an arm 1024 extending substantially perpendicular to the shaft 1022, the arm 1024 positioned at a switch lever 1030 of a circuit breaker 1032 for moving open the switch lever 1030 of the circuit breaker 1032, and having a manually disconnectable coupling 1026 between the shaft 1022 and the arm 1024.

The method may also deploy an adhesive 4028 to adhere the actuator 1020 to the face 1012 of the circuit breaker panel 1010.

The method may also add the step of rotating a sleeve 1023 about the shaft 1022 on the linear actuator 1020 by 180 degrees to selectively positon the arm 1024 at the switch lever 1030 of the circuit breaker 1032.

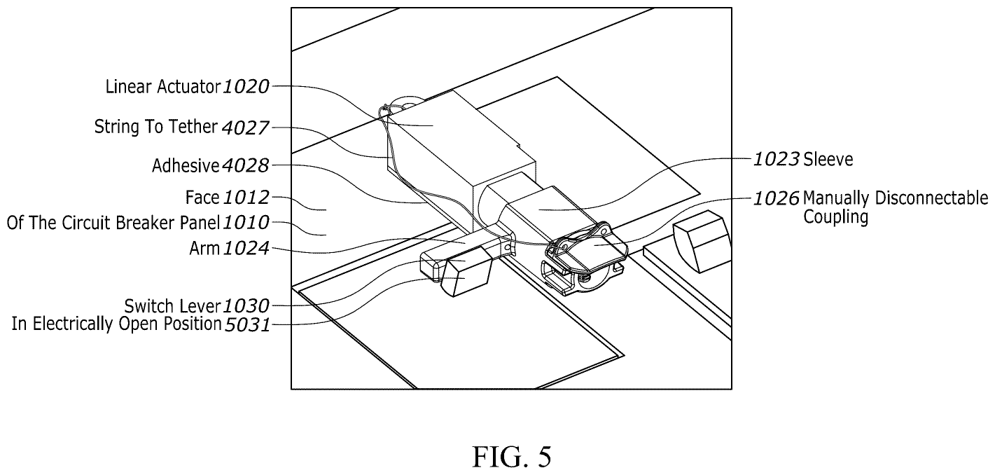

FIG. 5 illustrates a perspective view of the actuator 1020 deployed on a face 1012 of a circuit breaker panel 1010 in a safety operation when the actuator 1020 and the arm 1024 are both in extended positions and the switch lever 1030 is in an electrically open position after a shaft 1022 of the a actuator 1020 has automatically extended by operation of an alarm circuit electrically coupled to the actuator 1020 to detect a predetermined power condition according to embodiments of the present inventions.

The method continues as illustrated in FIG. 5 by the step of electrically activating the linear actuator 1020 to move the shaft 1022 when an alarm circuit detects a predetermined power condition to move the switch lever 1030 into an electrically open position from an electrically closed position.

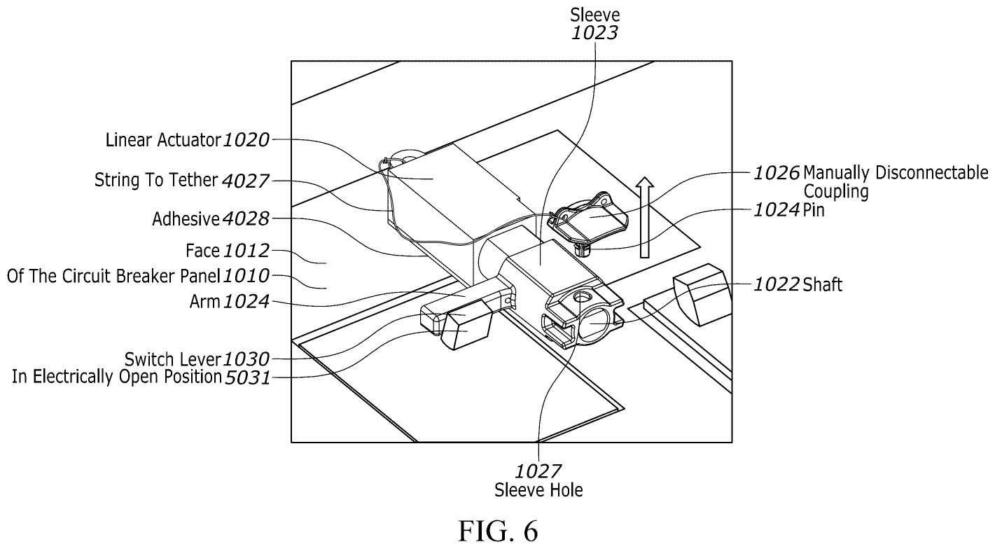

FIG. 6 illustrates a perspective view of the actuator 1020 deployed on a face 1012 of a circuit breaker panel 1010 with a manually disconnectable coupling 1026 removed by a finger 1080 of a user when the actuator 1020 and the arm 1024 are both in extended positons and the switch lever 1030 is the electrically open position according to embodiments of the present inventions.

The manually disconnectable coupling 1026 has a manually removable pin 1024 that fits in a shaft hole in the shaft 1022 and a sleeve hole 1027 in the sleeve 1023 to selectively couple the shaft 1022. The arm 1024 can be integrally formed of the same material as the sleeve 1023.

The method continues as illustrated in FIG. 6 by the step of a finger 1080 of a user manually disconnecting the manually disconnectable coupling 1026 between the shaft 1022 and the arm 1024 by the finger 1080 of user pulling a pin 1024. The method step has the finger 1080 of the user removing the manually disconnectable coupling 1026 when the actuator 1020 and the arm 1024 are both in extended positons and the switch lever 1030 is in the electrically open position.

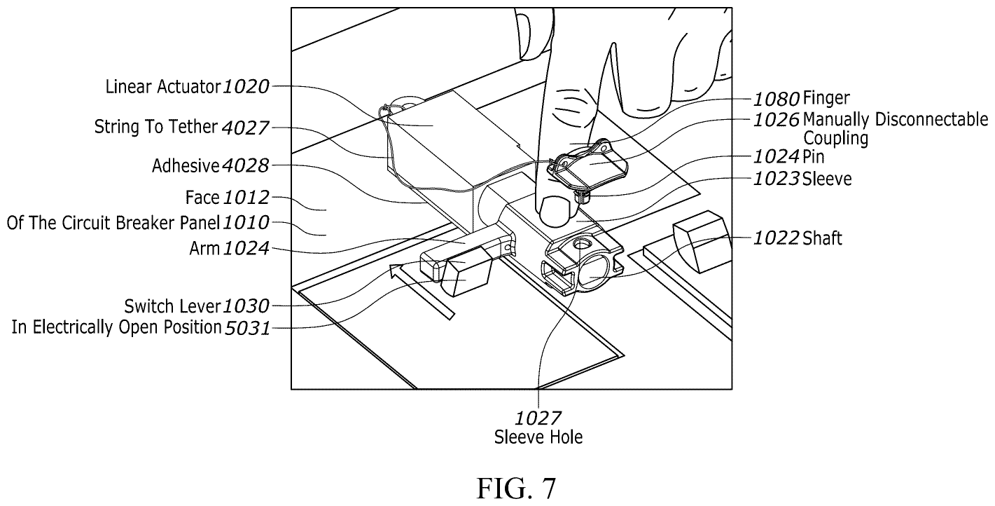

FIG. 7 illustrates a perspective view of the actuator 1020 deployed on a face 1012 of a circuit breaker panel 1010 and a finger 1080 of a user sliding the arm 1024 from the extended positon back to the retracted positon with the manually disconnectable coupling 1026 removed when the actuator 1020 is in the extended position and the switch lever 1030 is on the electrically open position according to embodiments of the present inventions.

The method continues as illustrated in FIG. 7 by the step of the finger 1080 of the user manually moving the arm 1024 away from the switch lever 1030 by sliding the sleeve 1023 on the shaft 1022.

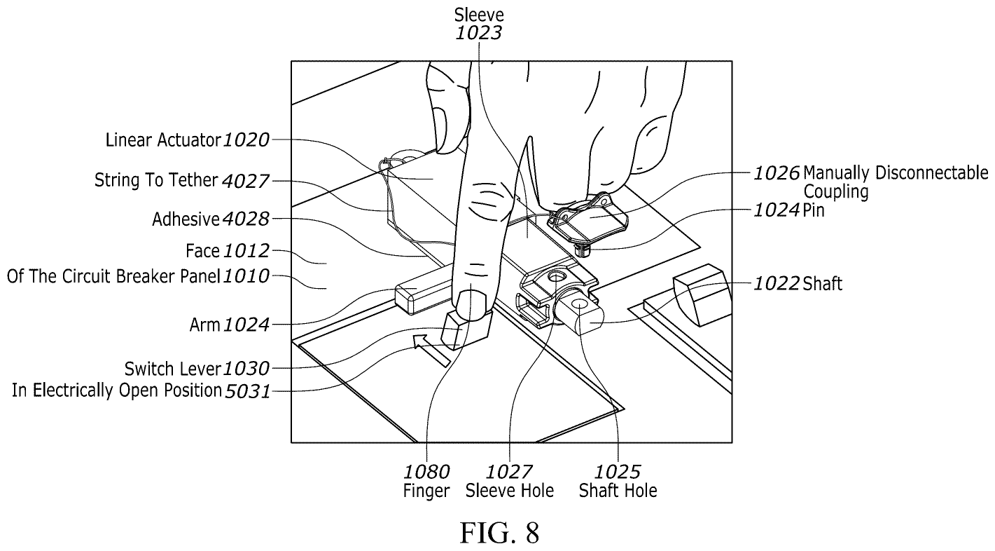

FIG. 8 illustrates a perspective view of the actuator 1020 deployed on a face 1012 of a circuit breaker panel 1010 and the finger 1080 of a user moving the switch lever 1030 is from the open positon to back to the electrically closed position to restore power with the manually disconnectable coupling 1026 removed when the arm 1024 is in the retracted positon and the actuator 1020 is in the extended position according to embodiments of the present inventions.

The method continues as illustrated in FIG. 8 by the step of the finger 1080 of the user sliding the arm 1024 from the extended positon back to the retracted positon with the manually disconnectable coupling 1026 removed when the actuator 1020 is in the extended position and the switch lever 1030 is in the electrically open position.

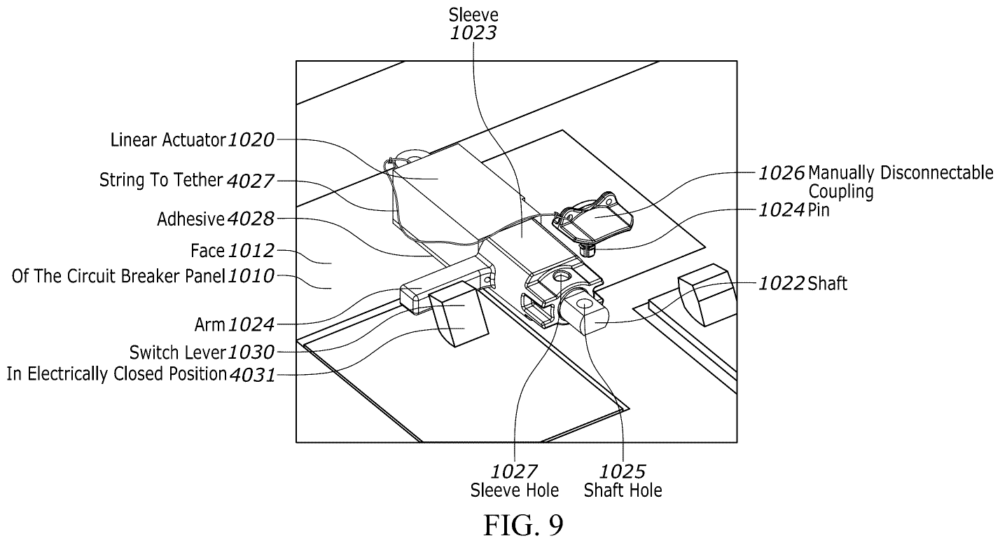

FIG. 9 illustrates a perspective view of the actuator 1020 deployed on a face 1012 of a circuit breaker panel 1010 with the manually disconnectable coupling 1026 removed when the arm 1024 is in the retracted positon and the actuator 1020 is in the extended position and the switch lever 1030 is in the electrically closed position according to embodiments of the present inventions.

The method continues as illustrated in FIG. 9 by the step of the finger 1080 of the user manually pushing the switch lever 1030 back into the electrically closed position.

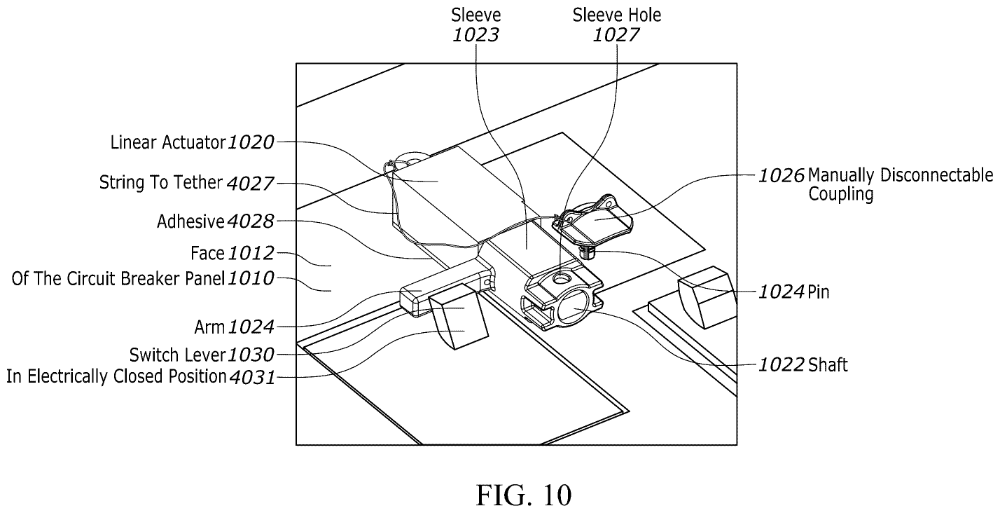

FIG. 10 illustrates a perspective view of the actuator 1020 deployed on a face 1012 of a circuit breaker panel 1010 with the manually disconnectable coupling 1026 removed when the arm 1024 is in the retracted positon and the actuator 1020 is in the retracted position and the switch lever 1030 is in the electrically closed position after the user has electrically caused the shaft 1022 of the a actuator 1020 to move back to the retracted position form the extended position after power was restored according to embodiments of the present inventions.

The method continues as illustrated in FIG. 10 by the step of electrically activating the linear actuator 1020 to move in a direction opposite a direction previously electrically activated.

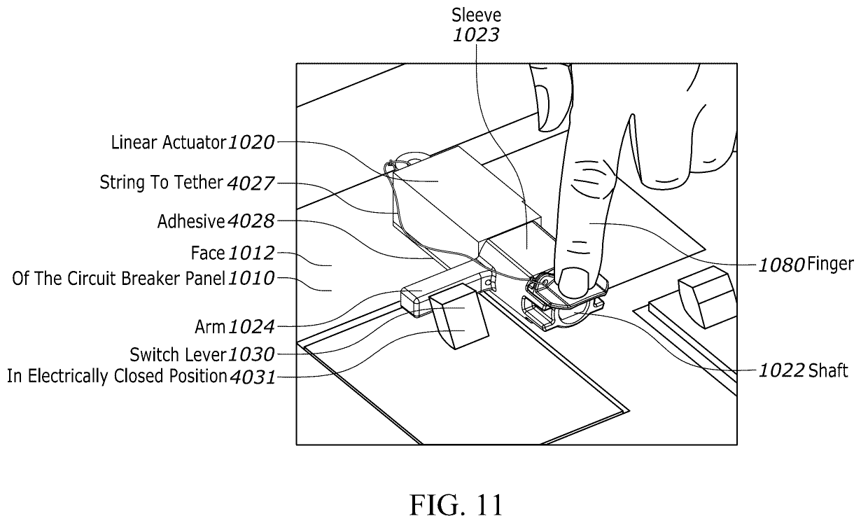

FIG. 11 illustrates a perspective view of the actuator 1020 deployed on a face 1012 of a circuit breaker panel 1010 with the manually disconnectable coupling 1026 re-inserted by the finger 1080 of the user to resume the normal ready operation when the arm 1024 is in the retracted positon and the actuator 1020 is in the retracted position and the switch lever 1030 is in the electrically closed position according to embodiments of the present inventions.

The method continues as illustrated in FIG. 11 by the step of the finger 1080 of the user manually reconnecting the manually disconnectable coupling 1026 between the shaft 1022 and the arm 1024 by the finger 1080 of the user inserting the pin.

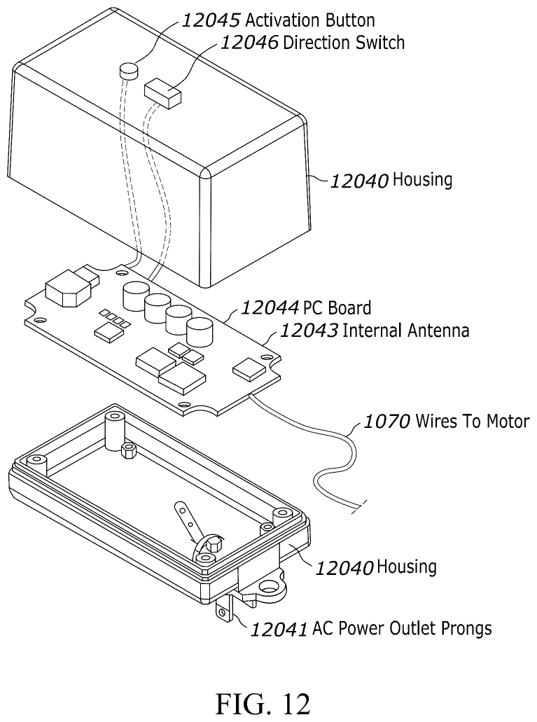

FIG. 12 illustrates an exploded perspective view of an alarm circuit with a PC circuit board 12044 and internal antenna 12043, an activation button 12045, a direction switch 12046, and a housing 12040, AC power outlet prongs 12041, and a wire 1070 coupled to a motor of the actuator according to embodiments of the present inventions. The activation button 12045 and the direction switch 12046 are connected electrically by wire to the PC circuit board 12044.

The housing 12040 is preferably an unshielded plastic housing to reduce cost and weight. The components on the PC circuit board 12044 are preferably all analog components for EMP hardening when unshielded.

The antenna 12043 is preferably and internal antenna formed on the PC circuit board 12044 inside the unshielded housing 12040 to achieve low cost and compact size, but can be a separate antenna or external antenna if needed.

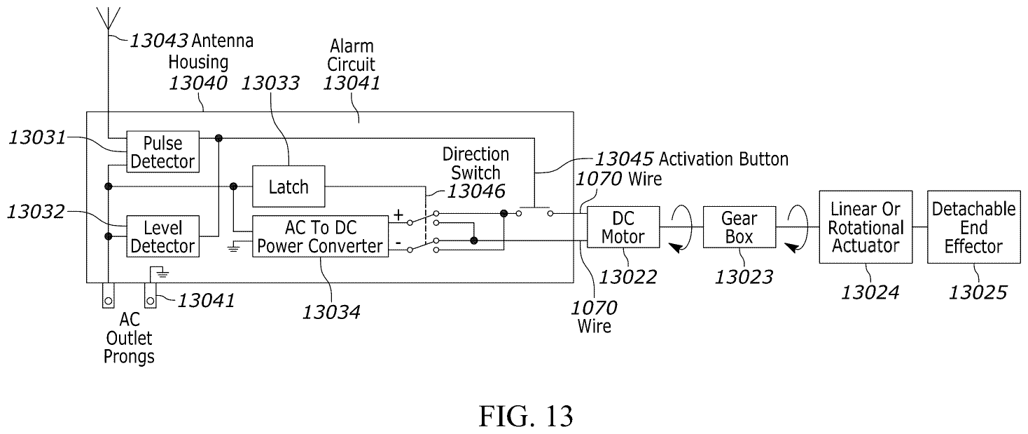

FIG. 13 illustrates a schematic block diagram of the apparatus system including the alarm circuit 13041 and the actuator 13024 with DC motor 13022 and gear box 13023 and an end effector 13025 according to embodiments of the present inventions.

An alarm circuit 13041 has a PC circuit board and an internal antenna 13043. An activation button 13045 and a direction switch 13046 of the housing 13040 with AC power outlet prongs 13041 and wires 1070 coupled to a DC motor 13022 of the actuator according to embodiments of the present inventions. The motor 13022 of the actuator 1020 is a DC motor or can be an AC motor. While AC power outlet prongs 13041 allow minimal electrical installation complexity, the alarm circuit 12041 can be direct wired to the AC line voltage of an electrician is available.

The actuator 13024 has a gear reduction gearbox 13023 between the DC motor 13022 and the shaft. The gear reduction gearbox 13023 provides speed reduction and torque improvement. The gear reduction gearbox 13023 is smaller than a solenoid and saves space.

The alarm circuit 13041 is electrically coupled to the actuator 13024 to detect a predetermined power condition and activate movement of the shaft on the actuator 13024 upon occurrence of the predetermined power condition. The predetermined power condition detected by the alarm circuit 13041 can be an out of range voltage on an AC mains utility power supply line at the AC outlet prongs 13041 detected by a level detector 13032. Examples of an out of range voltage include an E3 EMP (E3 Electromagnetic Pulse) or a CME (Coronial Mass Emission) or both. The predetermined power condition detected by the alarm circuit 13041 may include an E1 phase of an EMP (E1 Electromagnetic Pulse) detected by a pulse detector circuit 13031. This detection is optional due to the fast nature of an E1 that reaction time may be unsatisfactory. The pulse detector circuit 13031 receives input for detection from either the antenna 13043 or the AC line power at AC outlet prongs or both.

The pulse detector circuit 13031 can be configured to detect transient electromagnetic pulse disturbances associated with one or both E1 and E2 phases of an electromagnetic pulse by responding to pulse disturbance durations ranging from nanoseconds to microseconds. The pulse detector circuit 13031 can use timing filters to detect transient electromagnetic pulse disturbances associated with an E1 phase of an electromagnetic pulse by responding to pulse disturbance durations of nanoseconds. The pulse detector circuit 13031 can use timing filters to detect transient electromagnetic pulse disturbances associated with an E2 phase of an electromagnetic pulse by responding to pulse disturbance durations of microseconds.

It is preferred that an E2 EMP (E2 Electromagnetic Pulse) is not included in the predetermined condition because many E2 detection circuits are susceptible to false detections due to lighting and other conditions and due to the nature of an E2 that reaction time may be unsatisfactory. Nevertheless, if a highly reliable E2 detection circuit is used, or for other reasons, the predetermined power condition detected by the alarm circuit 13041 may also include an E2 detected by a pulse detector circuit. A highly reliable E2 detection circuit might not be able to be deployed with solely analog components for EMP hardening internal to an unshielded housing.

An AC to DC power converter circuit 13034 provides DC power to the DC motor 13022. The direction switch 13046 allows the DC motor 13022 to reverse direction. The direction can be reversed by a user operating the direction switch 13046. The direction can alternatively be reversed in a more automated way by the latch 13033 operating the direction switch 13046 when AC power appears at the AC outlet prongs 13041. An activation button 13045 allows a user to operate the actuator 13024 in either direction depending on the state of the direction switch 13046.

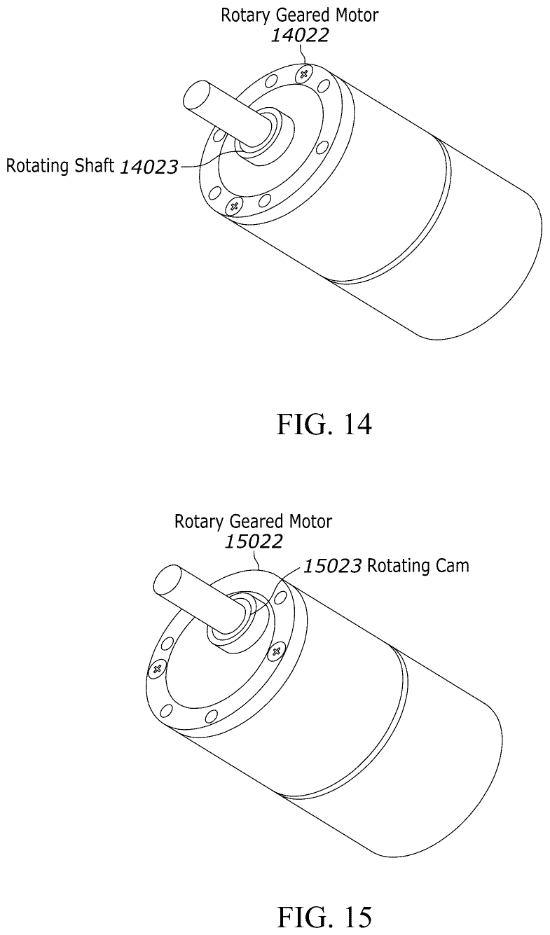

FIG. 14 illustrates a perspective view of a rotational actuator having a rotary geared electric motor 14022 with a rotating shaft 14023 according to alternative embodiments of the present inventions. The actuator is a rotational actuator with a gear reduction between an electric motor and the rotating shaft 14023 for torque conversion. The rotary geared electric motor 14022 is a DC motor or can be an AC motor.

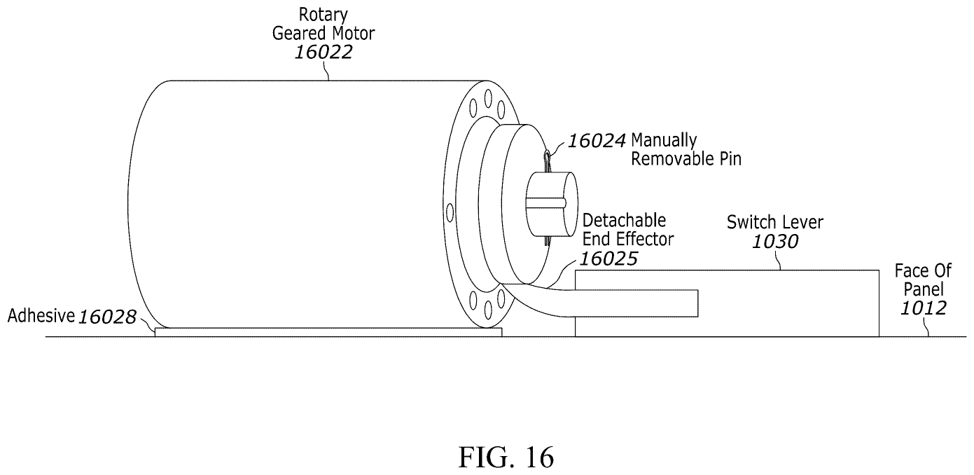

FIG. 15 illustrates a perspective view of a rotational actuator having a rotary geared motor 15022 with a rotating cam 15023 according to alternative embodiments of the present inventions. The rotary geared electric motor 15022 is a DC motor or can be an AC motor.

FIG. 16 illustrates a perspective view of a rotational actuator having a rotary geared electric motor 16022 with a of a rotational actuator with a detachable or removable end effector 16025 next to a breaker deployed on a face 1012 of a circuit breaker panel 1010 next to a switch lever 1030 of a circuit breaker 1032 according to alternative embodiments of the present inventions. An adhesive 16028 adheres the rotary geared electric motor 16022 is adhered to the face 1012 of a circuit breaker panel 1010.

The detachable or removable end effector 16025 is a manually disconnectable coupling having a manually removable pin 16024 such as a cotter pin fit in a shaft hole in the shaft and a sleeve hole in the removable end effector 16025 to selectively couple the shaft.

Any letter designations such as (a) or (b) etc. used to label steps of any of the method claims herein are step headers applied for reading convenience and are not to be used in interpreting an order or process sequence of claimed method steps. Any method claims that recite a particular order or process sequence will do so using the words of their text, not the letter designations.

Unless stated otherwise, terms such as “first” and “second” are used to arbitrarily distinguish between the elements such terms describe. Thus, these terms are not necessarily intended to indicate temporal or other prioritization of such elements.

“Reference characters corresponding to elements recited in the detailed description and the drawings may be used in conjunction with the recitation of the same element or group of elements in the claims. The reference characters, however, should be enclosed within parentheses so as to avoid confusion with other numbers or characters which may appear in the claims. The use of reference characters is to be considered as having no effect on the scope of the claims.” The Manual of Patent Examining Procedure (MPEP) issued by the United States Patent and Trademark Office, chapter 608.01(m) (Form of Claims).

Any trademarks listed herein are the property of their respective owners, and reference herein to such trademarks is generally intended to indicate the source of a particular product or service.

The abstract and the title are provided to comply with the rules requiring an abstract and a title that will allow a searcher or other reader to quickly ascertain the subject matter of the technical disclosure. It is submitted with the understanding that they will not be used to interpret or limit the scope or meaning of the claims. 37 CFR 1.72(b).

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure.

What is claimed is:

1. In a circuit breaker panel, an apparatus disposed on an outside face of the circuit breaker panel positioned at a switch lever of a circuit breaker for moving the switch lever of the circuit breaker, the apparatus comprising:
an electrical controller for determining a predetermined power condition; and
a mechanical actuator disposed on the outside face of the circuit breaker panel positioned at the switch lever of the circuit breaker configured to move the switch lever of the circuit breaker and operatively coupled to the electrical controller, the mechanical actuator comprising a solid member that selectively moves between an first position and a second positon to move the switch lever when the electrical controller determines the predetermined power condition.

2. In a circuit breaker panel according to claim 1, the apparatus further comprising an adhesive to adhere the mechanical actuator to the outside face of the circuit breaker panel.

3. In a circuit breaker panel according to claim 1, wherein the solid member comprises a manually resettable coupling configured for resetting by a finger of a user.

4. In a circuit breaker panel according to claim 1,
wherein the first positon is an extended positon;
wherein the second positon is an retracted positon; and
wherein the solid member is a shaft that selectively moves between the extended position and a retracted positon.

5. In a circuit breaker panel according to claim 4,
wherein the shaft comprises a manually resettable coupling configured for resetting by a finger of a user; and
wherein the apparatus further comprises an arm extending substantially perpendicular to the shaft.

6. In a circuit breaker panel according to claim 5, wherein the arm of the mechanical actuator is configured to fit on the face of the circuit breaker panel in a position to automatically move the switch lever into an electrically open positon from an electrically closed position upon the electrical controller determining the electrical condition and wherein the manually resettable coupling is configured to disconnect the shaft from the arm before manually moving the switch lever back into the electrically closed position.

7. In a circuit breaker panel according to claim 5, wherein the manually resettable coupling comprises a sleeve sized to fit over the shaft, wherein the sleeve couples to the arm such that the sleeve accommodates a 180 degree reversible position of the arm on the shaft.

8. In a circuit breaker panel according to claim 5, wherein the manually resettable coupling is a manually disconnectable coupling between the shaft and the arm.

9. In a circuit breaker panel according to claim 8, wherein the manually disconnectable coupling comprises a manually removable pin configured to selectively couple the shaft.

10. In a circuit breaker panel according to claim 8, further comprising a string tether between the manually disconnectable coupling and the mechanical actuator.

11. In a circuit breaker panel according to claim 1, wherein the mechanical actuator comprises a linear actuator with a gear reduction between an electric motor and the shaft.

12. In a circuit breaker panel according to claim 1,
wherein the apparatus further comprises an AC mains utility power supply line; and
wherein the electrical controller comprises a level detector operatively coupled to the mains utility power supply line for detecting an out of range voltage on the AC mains utility power supply line.

13. In a circuit breaker panel according to claim 12, wherein the electrical controller further comprises a pulse detector for detecting an E1 phase of an electromagnetic pulse.

14. A method of operating a mechanical actuator disposed on a face of a circuit breaker panel for moving a switch lever of a circuit breaker, the method comprising the steps of:
(a) adhering a mechanical actuator on a face of a circuit breaker panel, the mechanical actuator having a shaft that selectively moves between an extended position and a retracted positon and having an arm extending substantially perpendicular to the shaft, the arm positioned at a switch lever of a circuit breaker for moving the switch lever of the circuit breaker, and having a manually resettable coupling between the shaft and the arm;
(b) electrically activating the mechanical actuator to move the shaft when an electrical controller determines a predetermined power condition to move the switch lever into an electrically open position from an electrically closed position;
(c) manually disconnecting the manually resettable coupling between the shaft and the arm;
(d) manually moving the arm away from the switch lever;
(e) manually pushing the switch lever back into the electrically closed position;
(f) electrically activating the mechanical actuator to move in a direction opposite a direction electrically activated to move in said step (b); and
(g) manually reconnecting the manually resettable coupling between the shaft and the arm.

15. A method according to claim 14, wherein said step (a) of adhering comprises the substep of (a)(1) deploying an adhesive to adhere the mechanical actuator to the face of the circuit breaker panel.

16. A method according to claim 14,
wherein said step (c) of manually disconnecting comprises the substep of (c)(1) a finger of a user pulling a pin; and
wherein said step (g) of manually reconnecting comprises the substep of (g)(1) a finger of a user reinserting the pin.

17. A method according to claim 14, wherein said step (c) of manually disconnecting the manually resettable coupling between the shaft and the arm comprises the substep of (c)(1) removing the manually resettable coupling by a finger of a user when the mechanical actuator and the arm are both in extended positions and the switch lever is in the electrically open position.

18. A method according to claim 14, wherein said step (d) of manually moving the arm away from the switch lever comprises the substep of (d)(1) a finger of a user sliding the arm from the extended positon back to the retracted positon with the manually resettable coupling removed when the mechanical actuator is in the extended position and the switch lever is in the electrically open position.

19. A method according to claim 14, wherein said step (a) of adhering the mechanical actuator on the face of the circuit breaker panel comprises the substeps of
(a)(1) adhering a linear actuator; and
(a)(2) rotating a sleeve about the shaft on the linear actuator by 180 degrees to selectively positon the arm at the switch lever of the circuit breaker.

20. A method according to claim 14, wherein the electrically activating in said step (b) comprises the step of (b)(1) the electrical controller determines the predetermined power condition using a level detector for detecting an out of range voltage on an AC mains utility power supply line to trigger activation.
